(19) United States
(12) Patent Application Publication
(10) Pub. No.: US 2002/0065709 A1
(43) Pub. Date: May 30, 2002

(54) System for analyzing results of an employee survey to determine effective areas of organizational improvement

(76) Inventor: Kenneth D. MacKenzie, Lawrence, KS (US)

Correspondence Address: Jeffrey B. Williams, Lathrop & Gage LC, Suite 2800, 2345 Grand Boulevard, Kansas City, MI, 64108, US

(21) Appl. No.: 09/901,828

(22) Filed: Jul. 10, 2001

Related U.S. Application Data
(60) Provisional application No. 60/217,158, filed on Jul. 10, 2000.

(51) Int. Cl. G06F 17/60

(52) U.S. Cl. 705/10

(57) ABSTRACT

A system for analysis of employee surveys collected from the employees of an organization. A method is provided for identifying and analyzing probable causes of the survey results, and selecting variables for effecting remedies in order to improve future results. An employee opinion survey and an organizational diagnostic survey are concurrently administered to members of an organization. Results for the employee opinion survey and the organizational diagnostic survey are produced. Correlations between holonomic properties and items in the employee opinion survey are then determined. A linear programming model is run on results from the organizational diagnostic survey. Causal chains for the items in the employee opinion survey are identified, and feasible knobs for the organization are selected, to produce recommendations for organizational improvement.

### FIELD OF THE INVENTION

The present invention relates to the analysis of employee surveys collected from the employees of an organization. More specifically, the invention provides a method for identifying and analyzing probable causes of the survey results, and selecting variables for effecting remedies in order to improve future results.

### BACKGROUND OF THE INVENTION

Statement of the Problem

Rapid organizational change is due to a number of factors including new modes of information management and movement, shifts in competitive forces, economic changes which are mostly beyond management's ability to control and difficult to predict, changes in controlling regulations, and changes in how organizations are managed. These changes have reduced the length of product/service life cycles, changed the mix of skill sets needed to operate, caused uncertainty in cause/effect relationships, and have led to organizational design changes.

One result of these fundamental forces of change is that, increasingly, there have been changes in the relative dependence of managers and their employees. Managers must now manage subordinates with greater technical competence and employment mobility. These new relationships make managers relatively more dependent on their employees than was the case just a decade ago. At the same time, employees have more rights protected by increased regulation which, in turn, limits the options of managers to effect necessary organizational change Some of the new realities include less hierarchy with more organic organizational structures, greater emphasis on teamwork, and participative and decentralized decision making. There is less reliance on formal authority and more informal integrating roles, and more reliance on employees' knowledge and initiative to cope with changes. Managers engage in more planning and forecasting in order to cope with these changes.

Organizations have responded by seeking information to find out what their employees think about the properties and features of their organization. The need to know more about the opinions their employees hold about the organization is important to the success of a given organization.

A common tool for obtaining such information is to conduct an Employee Opinion Survey (EOS). An EOS seeks information from the employee about the features and properties of the organization. An EOS solicits self-reported written information from members of an organization about its features, properties, and outcomes using a survey instrument (usually a questionnaire). Typically, the items in an EOS elicit opinions and judgments of the type: “I am satisfied with my compensation”; I am satisfied with my career”; the organization is well managed,” etc. The employees are asked to provide their opinion (or judgment) on each item on a scale such as: (1) strongly disagree; (2) disagree; (3) neutral: (4) agree; and (5) strongly agree. It is routine to write, administer, and collect completed survey instruments and to tabulate the results.

An example from real life will help to understand some of the existing problems with EOSs. In this example, an instructor is given an end of the semester evaluation by the instructor's students. One common tool used in this type of evaluation is a Curriculum and Instruction Survey. This nine item survey includes the “bottom line” question: “Overall, I consider this instructor's teaching performance to be: (1) poor, (2) weak, (3) Good, (4) Very Good, and (5) Exceptional.” The students make their choices and the results are presented to both the instructor and his academic leaders. There is no stated criterion and there are no validation studies. It is assumed that a result of 4.0 is better than a 3.5. The professor with a result of 3.5 who wants to increase it to 4.0 has no direct evidence at all about what he or she should do to accomplish this modest goal. Should the instructor increase office hours, lower standards, restrict enrollment, bring pizza, or make more use of computer graphics? This raises two issues: First, the items do not incorporate context and situation, intuition, and involved experience in the course as every course uses the exact same items. Second, given the results, the instructor has no clue from the information about he or she could do to improve the results. The result is the establishment of informal norms and remedies which may or may not improve a criterion. The results become their own criterion.

The main points of the example are straightforward. First, interpreting the meaning of EOS results is difficult. It is an exercise in ambiguity to interpret the meaning or conclusions to be drawn from the results. This is due to a potential host of possible “causes” that are thought to have produced the results. Second, given the ambiguity of conclusions, there is even more ambiguity involved in deciding on recommendations for actions to improve the results. Third, the items are inherently limited in their incorporation of context, situation, involvement, and expertise. Even if the EOS is competently designed and executed, the context and situation can change. A problem emerges when one moves away from results to reach conclusions and to decide on recommendations because these steps involve expertise, experience, information, and intuition not included in the methods to produce the results.

Another way of visualizing the problem set forth above is to think of EOS results as values on a vertical or y-axis, where the “why” or x-axis is used to explain the results. This x-axis is missing in most EOSs.

The following description of uses the metaphor of ‘knobs’ on an old-fashioned radio. If the radio is playing a station and the listener is unhappy with what is being received, he or she might wish to turn the volume knob to alter the volume or the tuning knob to change the station. Ideally, an EOS result is like a radio broadcasting a program and the knob is an action the listener takes to change it. Knowing which knob to turn and turning it appropriately is more effective than randomly turning dials. The main problem is the ‘knoblessness’ of the usual EOS result. If the knobs were known, then one could improve EOS results more reliably. A holistic organization theory that provides a generic, ordered set of knobs helps one to reach conclusions and recommendations. Given such a theory, one can determine which knob or set of knobs is most likely to effect an improvement in an EOS result. In accordance with the present system, it is possible to perform knobby analyses of ‘knobless’ survey items in order to supplement and enhance the results from EOSs. Such ‘knobby’ analyses increase precision by linking those factors or processes under the control of management (‘knobs’) with the results from the knobless EOS.

EOSs provide data and results. Results obtained must be translated into conclusions and conclusions into recommendations in order to support fact-based decisions designed to improve the organization. Reaching conclusions and deciding on recommendations involves interpreting the EOS results in the context of the specific organizational situation. Management is not generally passive; it typically attempts to control many processes within the organization. Exercising these controls provides management the means for improving results. A major problem, however, is to match that which management can control and the EOS results in order to improve these results.

Traditional EOS results present several problems for their use. First, it is difficult to interpret the meaning of the results due to a host of possible ‘causes’ that could be seen as having produced them. Second, given the ambiguity of the conclusions, there is even more ambiguity in deciding on recommendations to improve the results. EOSs produce ambiguous conclusions and recommendations because they are ‘knobless’, or lacking underlying processes which are controllable by management. The present invention addresses these and other problems.

Solution to the Problem

The present system improves the use of Employee Opinion Survey results by finding and then controlling the ‘knobs’ representing the processes under the direct influence of managers.

There are several issues in using Employee Opinion Surveys that are dealt with by ‘knobby analyses’ of knobless survey items. First, EOS items usually lack a knob or causal process which can be used to explain their variances. Second, the methodology of organizational surveys customarily focuses on the data expertise technical problems of item construction, sampling, and analyses of data to produce results.

A remedy to the above problems is to administer two surveys concurrently: an EOS and a ‘knobby’ survey based on a holistic organization theory. The knobby survey, derived from a holistic organization theory, provides a generic set of processes with which one may explain the variance in the EOS items.

The theory of the organizational hologram has evolved operationally into a family of Organizational Diagnostic Survey (ODS) forms which generate sets of results representing managerially controllable processes or combinations of processes. That is, the ODS provides a set of x-axis variables that can be employed to explain variability in EOS results, which are viewed as dependent variables plotted on the y-axis. Every item in an ODS form is “knobby”. The relationships among the questions and higher order results are causal and structured with known interdependencies. Combining ODS and EOS allows knobby analyses of knobless survey items.

The present system uses the theory of the organizational hologram and its Organizational Diagnostic Survey (ODS) to provide a knobby survey with a plurality of holonomic properties. A problem in performing knobby analyses is that the large number of holonomic properties and EOS items may generate over a thousand correlations for each split of the database. A three-step procedure for reducing this complexity is used in the present system. Step one eliminates those knobs whose potential improvement value (from the linear programming model) is less than or equal to unity. This step eliminates a large number of the correlations. Step two eliminates the remaining correlation coefficients whose significance is less than 0.01. Step two results in a further reduction of correlations. Step three reduces the surviving knobs by eliminating all dominated knobs. A knob dominates another with respect to an EOS item if it has a larger potential improvement value and a higher correlation with the EOS item. Step three also eliminates a significant number of additional correlations.

The present system comprises a method for obtaining and using additional information to augment the results of an Employee Opinion Survey (EOS). Employee Opinion Surveys typically include items about a set of characteristics or properties of an organization that are of interest to management, such as employee satisfaction with leadership, compensation, direction of the organization, treatment by management, ethics, and many others. Results are often useful to management in evaluating its current policies and performance.

There is wide variation in Employee Opinion Surveys in both content and competence of design and execution. The present system accepts this variation as a given and offers a new method for improving their use. This method can be used to augment EOSs containing organizationally related items at most levels of competence.

The process performed by the present system may be summarized as follows.

An employee opinion survey and an organizational diagnostic survey are concurrently administered to members of an organization. Results for the employee opinion survey and the organizational diagnostic survey are produced. Correlations between holonomic properties and items in the employee opinion survey are then determined. A linear programming model is run on results from the organizational diagnostic survey. Causal chains for the items in the employee opinion survey are identified, and feasible knobs for the organization are selected, to produce recommendations for organizational improvement.

### BRIEF DESCRIPTION OF THE DRAWINGS

FIG. 1 is a block diagram illustrating exemplary steps performed in practicing one embodiment of the method of the present invention;

FIG. 2 is a block diagram further illustrating exemplary steps performed in block 110 of FIG. 1;

FIG. 3 is a block diagram further illustrating exemplary steps performed in block 115 of FIG. 1;

FIG. 4 is a block diagram further illustrating exemplary steps performed in block 125 of FIG. 1;

FIG. 5 is a block diagram further illustrating exemplary steps performed in block 130 of FIG. 1; and

FIG. 6 is a block diagram further illustrating exemplary steps performed in block 135 of FIG. 1.

### DETAILED DESCRIPTION

The description of the present system makes use of a set of terms and concepts which are defined as follows.

An ‘item’ is a statement for which an opinion, judgment, or attitude is sought from a respondent as part of a survey instrument.

A ‘survey instrument’ consists of a set of items.

A ‘knob’ is a process that establishes and defines a causal and/or functional relationship between the process cause and its outcome(s).

A ‘knobby scale’ is a rating scale with unit intervals in which the opinions (judgments) of the respondent is measured on a continuum for the degree to which a process is a property of an organization. When a judgment is sought regarding to what extent a process described by an item is working in the organization, the knobby scale looks like the following (for a five point scale):

| Never | Rarely | Sometimes | Often | Always | Don't Know |
|---|---|---|---|---|---|
| 1 | 2 | 3 | 4 | 5 | 7 |

A ‘knobless item’ is one in which an opinion is ought about the state of a property, outcome, or characteristic of an organization (e.g., satisfaction with compensation) without information about the state of the set of processes that account for its value. The property, outcome, or characteristic is actually a judgment about some unknown process or processes.

A ‘knobless scale’ is a rating scale in which the opinion or judgment (attitude) of the respondent is measured on a continuum from a negative to a positive (or vice versa) with an equal number of positive and negative response possibilities and one middle or neutral category. When an opinion or judgment (attitude) is sought about the items there is a variety of possible descriptions of the knobless scale. For example, knobless scales often look like the following (for a five point knobless scale).

| Strongly | | | | Strongly | Don't |
|---|---|---|---|---|---|
| Disagree | Disagree | Neutral | Agree | Agree | Know |
| 1 | 2 | 3 | 4 | 5 | 7 |

An Employee Opinion Survey (EOS) is a questionnaire administered to employees of an organization to elicit Their opinions, judgments, and attitudes about properties, characteristics or features of the organization whose items are knobless and employ knobless scales.

An Organizational Diagnostic Survey (ODS) is a holistic organizational diagnostic survey instrument based on the theory of the organizational hologram and whose items are knobby and employ knobby scales.

Coding information in an ODS Form consists of personal information for each respondent usually including but not limited to name, position, unit, years in organization (tenure), rank, gender, age, ethnicity, education, compensation (salary, wages, benefits, etc.).

‘Splits’ are divisions of the respondents based on coding information. For example, a split could be defined by gender, in order to determine if men generate different results than women on the surveys.

EOS results are the means and distribution of the responses of those in the client organization for each EOS item. EOS results can be reported for any split, including the entire organization.

ODS results are the means and distribution of the holonomic properties of those in the client organization. ODS results can be reported for any split including the entire organization.

Holonomic Properties Include the Following

Desired Organizational Characteristics

Holonomic Processes

Key Implementing Processes

Dynamic Organizational Level Congruency Conditions

Dynamic Bonding Congruency Conditions

Knobby and Knobless Survey Items

A knob is a process that establishes and defines a causal and functional relationship between the process cause and its outcome. Knobs, when activated by an event and under the control of management, can change how the organization operates. Knobs define a causal and functional relationship between the processes they represent and their outcomes. Assessing knobs requires one to employ a knobby scale. A knobby scale is usually a 5, 7, or 9-point rating scale in which the opinions (judgments) of the respondent is measured on a continuum for the degree to which a process is a property of an organization. When a judgment is sought regarding to what extent a process described by an item is working in the organization, the knobby scale looks like the following:

| Never | Rarely | Sometimes | Often | Always | Don't Know |
|---|---|---|---|---|---|
| 1 | 2 | 3 | 4 | 5 | ? |

A knob with a knobby scale provides direct and explicit information for how to improve the score. Namely, deploy the process more consistently across the organization. A set of knobby items is also knobby. That is, the knobby items can be combined into higher order processes. Conversely, higher order processes can be disaggregated into constituent sub-processes.

A knobless item is one in which an opinion is sought about the state of a property or characteristic of an organization (e.g., satisfaction with compensation) without information about the state of the set of processes that account for its value. Essentially, a knobless item asks for an opinion about the state of the outcomes of some set of unknown processes. Knobless items have ambiguous antecedents.

Most EOS items are inherently knobless in that they ask for an opinion about a property or characteristic of an organization. The property or characteristic is actually an outcome of some unknown process or processes. While in some cases there may be ample understanding of the set of processes that bring about the observed result, in most cases the causes, because they are unsought in the EOS, are problematic. In short, EOS items are usually knobless.

Assume that x represents a causal process, as measured by a knobby item, and y represent a property or characteristic of an organization, as measured by a knobless survey item. A knobless survey item is essentially a measure of y=f(y). A knobby analysis of a knobless survey item provides a relationship or function relating the x-axis, representing the knob, and the y-axis, representing the knobless EOS item. In principle: y=f(x). Thus, if the EOS item result is y₁, it would represent a knob at the level of x₁. If management desired to increase y₁ to y₂, it would have to turn the knob from x₁ to x₂.

Returning to the example presented in the ‘Problem’ section above, the professor could improve his teaching evaluation if he knew the knobs to improve his approval results. Ideally, knobs represent processes under the control of management. That way, if there is a strong link between a knob, x, and a knobless survey item, y, one would be able to match that which management can control with a desired EOS result. By combining those knobby items over which management has some control and knobless EOS items, one can associate that which is under the control of management with the desired organizational outcomes or properties. This association can be done by using standard statistical methods provided that one simultaneously collects both knobby and knobless survey items.

Because of the immense variety of possible EOS questions, it is necessary to create a generic set of knobs that cover most major aspects of an organization's environments, strategic direction, organizational processes and technologies, and results. A holistic organization theory, called the theory of the organizational hologram, provides the set of knobs. This theory is well known in the art (cf. K. Mackenzie, “The Organizational Hologram: The effective Management of Organizational Change”. Kluwer, Boston, Mass., 1991, which is incorporated herein by reference). Knobs based on such a holistic theory can be used to reveal possible strong, statistically significant relationships to “explain” EOS results. These theory-based knobs of the processes under the control of management can be turned to improve both the underlying processes and the values of the results of the knobless EOS survey items.

A concept employed in holistic organization theory, called an “Organizational Hologram”, defines a hierarchy of knobs whose structures can be exploited in performing knobby analyses. Twelve holonomic processes allow the derivation of six Desired Organizational Characteristics or DOCs. There are more levels above the DOCs, and an intermediate level has been inserted between the DOCs and Holonomic Processes (HPs) called Key Implementing Processes (KIPs). The six DOCs and the twelve HPs are listed in Table 1 (below), and the concept of KIPs is explained below.

TABLE 1
The Eighteen Major Properties of the Organizational Hologram

| | Description |
|---|---|
| Holonomic | |
| Properties | |
| Desired | |
| Organizational | |
| Characteristics | |
| DOC1 | Clarity of Direction |
| DOC2 | Clarity of Structures |
| DOC3 | Clarity of Measurement |
| DOC4 | Successful Goal Achievement |
| DOC5 | Results Oriented Problem Solving |
| DOC6 | Associates Are Assets and Resources |
| Holonomic | |
| Processes | |
| HP1 | Establishing and Maintaining Clear Strategic Direction |
| HP2 | Defining and Updating the Organizational Logic |
| HP3 | Ensuring Best Decision Making |
| HP4 | Adapting to Ensure Position Clarity |
| HP5 | Ensuring Systematic Planning that Is Workable, |
| | Involved and Understood |
| HP6 | Integrating Employee Selection, Development and Flow |
| | with the Strategic Direction |
| HP7 | Nurturing and Rewarding Opportunistic and Innovative |
| | Problem Solving |
| HP8 | Ensuring Healthy Problem Solving throughout the |
| | Organization |
| HP9 | Setting Tough and Realistic Performance Standards |
| HP10 | Operating Equitable and Effective Rewards Systems |
| HP11 | Ensuring Compatibility of Interests |
| HP12 | Encouraging and Rewarding Ethical Behavior for All |
| | Associates |

The interdependencies among the KIPs, the twelve HPs, and the six DOCs are assumed to be known. Some exemplary dependencies are presented in Tables 2a-2c, below. The HPs are made up of sets of KIPs and the DOCs are based primarily on four of the HPs. Each KIP is comprised of a specific set of items in the Organizational Diagnostic Survey (ODS) and the items in each KIP are a member of one and only one KIP. The KIPs form a set partition of the items in an ODS. Many of the KIPs are constituent of more than one HP. Thus, there is a sequence of increasing generalization as one moves up the analytical hierarchy from ODS items to KIPs to HPs to DOCs. The KIPs, HPs, DOCs, and dynamic congruency conditions are considered to be holonomic properties of an organization.

TABLE 2a
Interdependencies Among the KIPs, HPs, and DOCs

| K10. Applying | K10. Applying | K14. Ensuring | K32. Ensuring |
|---|---|---|---|
| the Organiza- | the | Compatible | Ethical |
| tional Rewards | Organizational | Interests | Decision |
| Systems | Rewards Systems | of Results | Making |
| K13. Auditing & | K15. Using | K20. Ensuring | |
| Reviewing | Tough & | Compatibility of | |
| Organizational | Realistic | Associate | |
| Progress | Performance | Goals & | |
| | Standards | Strategies | |
| K15. Using | K16. Ensuring | K21. Relating | |
| Tough & | Job | Compatibility | |
| Realistic | Performance | of Interests & | |
| Performance | Measurement & | Unit Goals | |
| Standards | Application | | |
| K19. Ensuring | K17. Applying | K22. Ensuring | |
| Position Rewards | Total | Compatible | |
| Systems | Compensation | Interests | |
| | to Associates | Among | |
| | | Stakeholders | |
| K73. Deploying | K19. Ensuring | K23. Ensuring | |
| Improved | Position | Compatible | |
| Technologies | Rewards | Interests | |
| | Systems | by HRM | |
| HP9 | HP10 | HP11 | HP12 |
| Setting Tough & | Operating | Ensuring | Encouraging & |
| Realistic | Equitable & | Compatibility of | Rewarding |
| Performance | Effective | Interests | Ethical |
| Standards | Rewards Systems | | Behavior for |
| | | | All Associates |
| Clarity of | Clarity of | Successful Goal | Clarity of |
| Measurement | Structures | Achievement | Measurement |
| Successful Goal | Clarity of | Associates Are | Associates Are |
| Achievement | Measurement | Assets/Resources | Assets/ |
| | | | Resources |

TABLE 2b

| K2. | K25. Ensuring | K33. Using | K22. Ensuring |
|---|---|---|---|
| Understanding & | Associates Are | Organizational | Compatible |
| Use of | Assets & | Forums | Interests |
| Environments | Resources | | Among |
| | | | Stakeholders |
| K3. | K26. Linking | K37. Amplifying | K30. |
| Developing & | Training & | Rewards | Encouraging |
| Using the | Development to | | Best Decision |
| Mission | Strategic | | Making |
| Statement | Direction | | |
| K4. | K27. Ensuring & | K38. Nurturing & | K33. Using |
| Establishing & | Developing | Rewarding | Organizational |
| Using Goals, | Associates | Opportunistic & | Forums |
| Strategies & | Qualifications, | Innovative | |
| Tactics | Knowledge & | Problem | |
| | Commitment | Solving | |
| K5. Using | K30. Encouraging | | K34. Managing |
| Strategic | Best Decision | | Conflict |
| Long Range & | Making | | |
| Tactical Plans | | | |
| K6. Setting | K33. Using | | K35. Ensuring |
| Environmental & | Organizational | | Results |
| Strategic | Forums | | Oriented |
| Assumptions | | | Problem |
| | | | Solving |
| K11. Ensuring | | | K39. Ensuring |
| Results | | | Quality |
| Measurement | | | |
| K29. Involving | | | |
| Associates In | | | |
| Planning & | | | |
| Implementation | | | |
| K33. Using | | | |
| Organizational | | | |
| Forums | | | |
| K72. Selecting | | | |
| Improved | | | |
| Technologies | | | |
| K73. Deploying | | | |
| Improved | | | |
| Technologies | | | |
| K74. Managing | | | |
| New | | | |
| Technology | | | |
| Integration | | | |
| HP5 | HP6 | HP7 | HP8 |
| Ensuring | Integrating | Nurturing & | Ensuring |
| Systematic | Associate | Rewarding | Healthy |
| Planning | Selection, | Opportunistic & | Problem |
| that is | Development & | Innovative | Solving |
| Workable, | Flow with | Problem- | Throughout |
| Involved & | the Strategic | Solving | the |
| Understood | Direction | | Organization |
| Clarity of | Clarity of | Successful | Results |
| Direction | Structures | Goal | Oriented |
| | | Achievement | Problem |
| | | | Solving |
| Clarity of | Associates Are | Results | Associates Are |
| Measurement | Assets/ | Oriented | Assets/ |
| | Resources | Problem | Resources |
| | | Solving | |

TABLE 2c

| K10. Applying | K10. Applying | K14. Ensuring | K32. Ensuring |
|---|---|---|---|
| the Organiza- | the | Compatible | Ethical |
| tional Rewards | Organizational | Interests | Decision |
| Systems | Rewards Systems | of Results | Making |
| K13. Auditing & | K15. Using | K20. Ensuring | |
| Reviewing | Tough & | Compatibility of | |
| Organizational | Realistic | Associate | |
| Progress | Performance | Goals & | |
| | Standards | Strategies | |
| K15. Using | K16. Ensuring | K21. Relating | |
| Tough & | Job | Compatibility | |
| Realistic | Performance | of Interests & | |
| Performance | Measurement & | Unit Goals | |
| Standards | Application | | |
| K19. Ensuring | K17. Applying | K22. Ensuring | |
| Position Rewards | Total | Compatible | |
| Systems | Compensation | Interests | |
| | to Associates | Among | |
| | | Stakeholders | |
| K73. Deploying | K19. Ensuring | K23. Ensuring | |
| Improved | Position | Compatible | |
| Technologies | Rewards | Interests | |
| | Systems | by HRM | |
| HP9 | HP10 | HP11 | HP12 |
| Setting Tough & | Operating | Ensuring | Encouraging & |
| Realistic | Equitable & | Compatibility of | Rewarding |
| Performance | Effective | Interests | Ethical |
| Standards | Rewards Systems | | Behavior for |
| | | | All Associates |
| Clarity of | Clarity of | Successful Goal | Clarity of |
| Measurement | Structures | Achievement | Measurement |
| Successful Goal | Clarity of | Associates Are | Associates Are |
| Achievement | Measurement | Assets/Resources | Assets/ |
| | | | Resources |

The theory of the organizational hologram thus provides a coherently structured set of hierarchy of knobs under the control of management which is used by the present system to explain the results from an Employee Opinion Survey (EOS). While the theory of the organizational hologram is arguably a holistic theory with clear linkages among its processes, the usual EOS lacks this conceptual clarity. Thus, the linkages among the EOS items is often unclear and, derivatively, so are the links between the EOS items and the holonomic properties of an organization.

Because the relationships among the knobs are specified, they can be used to investigate and even “explain” the variance in the results of EOS items. Furthermore, since the knobs are hierarchically ordered, it is possible to find a relationship at one level and then “open up” the knob into its constituent knobs. This allows an analyst to improve the specificity of the possible causal links between knobs and EOS item results. On the other hand, there is no guarantee that the EOS items are causally linked either (a) to each other or (b) to the possible causal knobs from the theory. Thus, the process of investigating the impacts of any of the knobs on any specific EOS item is more of an empirical than a theoretical problem. Consequently, part of the process of performing knobby analyses of knobless EOS items is necessarily a problem of determining and choosing among a set of statistically significant empirical relationships.

Further analysis is effected, in the present system, by linear programming to exploit the known analytical structure of the theory of the organizational hologram and a logical scheme for shifting through the streams of data and results to select the “best” knobs for improving EOS item scores. The outcomes of such knobby analyses provide a basis for arriving at informed conclusions and recommendations that go beyond the statistical analyses of EOS instruments.

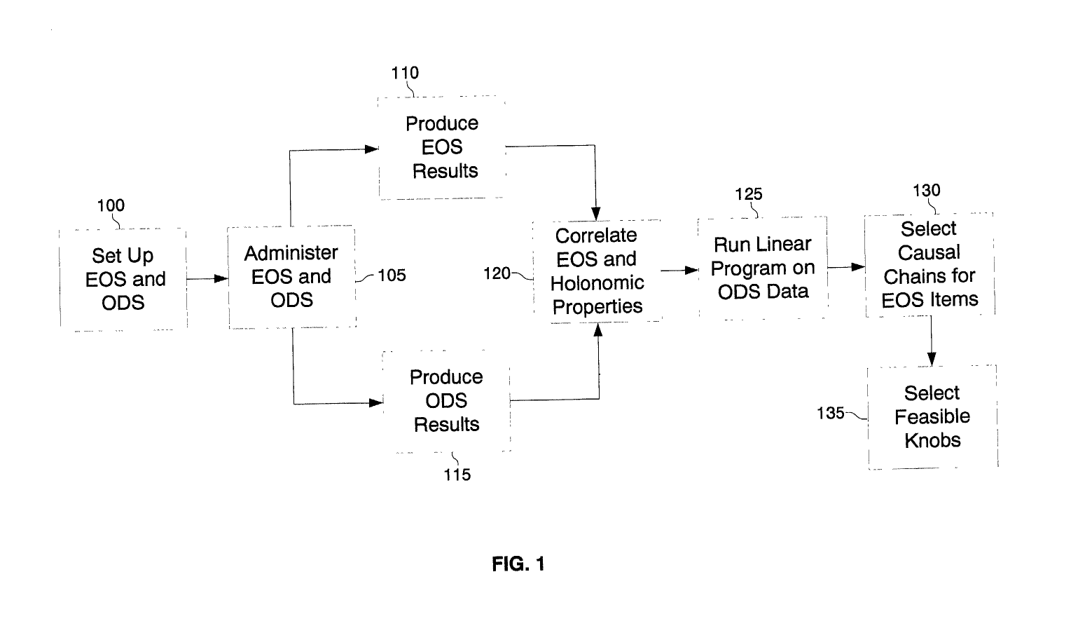

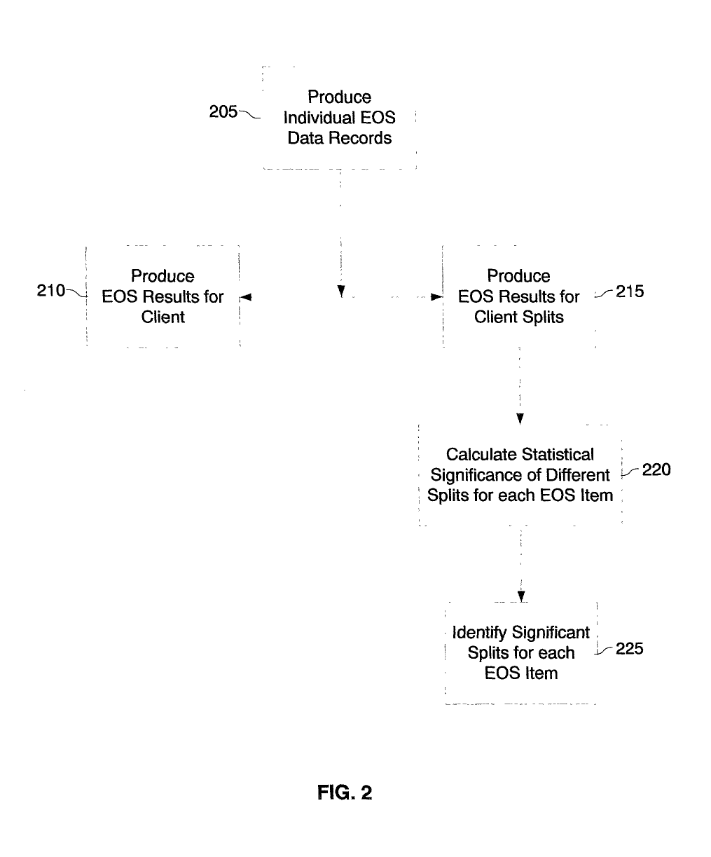

FIG. 1 is a block diagram illustrating exemplary steps performed in practicing one embodiment of the method of the present invention. As shown in FIG. 1, in an exemplary embodiment of the present system, the Knobby Analysis Process comprises 7 steps. These steps are described below. Blocks 110, 115, 125, 130, and 135 of FIG. 1 are expanded in FIGS. 2 through 6 in order to show operational details.

There are several preliminary procedures that are performed prior to those comprising the present system. These procedures are shown as step 100 in FIG. 1. Initially, an Organizational Diagnostic Survey (ODS) is developed for the Client Organization. In an exemplary embodiment of the present system, there are at least three phases involved in developing the specific ODS for the clients. The first phase is to work with the client organization to become specific about which members of the client organization will be involved in an organizational study. These decisions determine the choice of the ODS Form to be used with different members of the sample. The next phase is to work with the client organization to develop the coding information for purposes of individual respondent identifying information. The third phase is to work with the client to customize some of the language in the ODS instrument so that the items are understood within the context of the client.

The next preliminary step is to develop the Employee Opinion Survey (EOS) instrument for the client organization. In an exemplary embodiment of the present system, the EOS instrument contains items that are deemed by management of the client organization to have sufficient interest to be included in the study. There is no known a priori theory for the development of an EOS. The first stage begins with working with the client to identify issues. Next, a consultant works with the client to decide on the final EOS items for the EOS instrument. Finally, an EOS instrument is produced for final approval by the client.

Prior to implementing the method of the present system, negotiation takes place between the client organization and the consultant to contract, commission, and approve the study. Usually this entails full disclosure of the process to be followed, description of the types of results, conclusions, and recommendations, a time frame, logistical arrangements, costs estimates, and a full and frank discussion of the client needs and expectations. At this point, the client makes available background information to the consultant. Decisions are reached on the selection of the survey instruments, selection of the sample, methods of administration, and procedures for reporting the findings of the study.

Next, the survey instruments are determined. The organization and the consultant jointly agree to the following:

1. he exact text of the Employee Opinion Survey.

2. The coding information for each respondent (e.g., name, title, rank, unit, gender, race, years of experience, etc.).

3. The choice of the Organizational Diagnostic Survey Instrument. Tables 2a-2c list the characteristics of Three ODS Forms currently used in ODS Instruments.

After determining which survey instruments are to be used, the organization and the consultant jointly agree in principle on which members of an organization will be included in the study. This choice may involve all members or any agreed upon subset.

Next, the organization and the consultant jointly agree on the method for administering the EOS and ODS. Choices include but are not limited to these: mailing a copy of the EOS and ODS instruments to the sample; use of e-mail to obtain data from the EOS and ODS instruments from the client sample; and group administration of the EOS and ODS instruments to subsamples of the sample population. It is essential that both the EOS and ODS instruments be administered at the same time for every member of the client sample.

At step 105, the EOS and ODS instruments are concurrently administered to the client organization. Because the present system involves using the ODS results to explain the EOS results as well as to produce both EOS and ODS results, it is essential that both instruments be given concurrently. That way, one knows which responses on the EOS instrument goes with the ODS instrument. The method of administration can be by mail, by internet, by directed group meetings, or the like.

At step 110, the EOS results are produced for the client. The method of production of the EOS results is further illustrated in FIG. 2. As shown in FIG. 2, at step 205, each completed EOS instrument is entered into a data record for the individual respondent. These are used to produce EOS results for the client organization (step 210), and to produce results for desired data splits (step 215). At step 220, the different groups in a split are analyzed statistically to determine whether or not there is a statistically significant difference for each EOS item, for each split. Then, at step 225, the significant splits for each EOS items are identified and placed in tables.

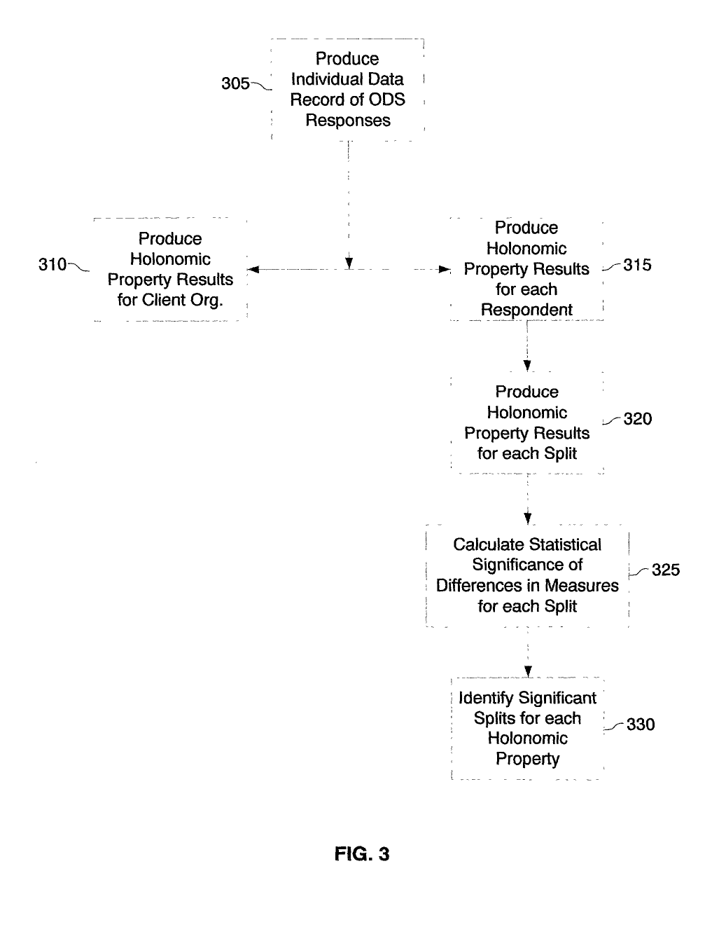

As shown in FIG. 1, at step 115, the ODS results are produced for the client. The method for production of the ODS results is more complex than the production of EOS results because the EOS results are directly defined by each item whereas the ODS data must be transformed into holonomic properties. The process is further illustrated in FIG. 3. As shown in FIG. 3, at step 305, the first stage is to produce individual data records of ODS responses. At step 310, these data records are then computed into the holonomic properties results for the entire organization. Then, in order to effect the use of ODS results to explain the variance in the EOS items, the holonomic properties are then calculated for each respondent and is placed in a data record (step 315). As in the use of the EOS, holonomic property results are produced for each split, at step 320, and the statistical significance of any differences is calculated by examining the differences in means for each holonomic property for each split (step 325). Finally, at step 330, the statistically significant differences in means for each holonomic property and desired splits are tabulated. The splits for the EOS results are usually done for the ODS results.

At step 120 (in FIG. 1), correlations between holonomic properties and EOS Items are calculated. This step involves creating a composite record for each respondent. The first set of files include the coding information for the individual respondent. The second set of files include the EOS item responses. The third set of files include the ODS-based holonomic properties for each respondent. The correlations are between the holonomic properties and the EOS item responses. Correlation coefficients are established for three sets following the analytical hierarchy of the holonomic properties:

1. EOS against the Six Desired Organizational Characteristics

2. EOS against the Twelve Holonomic Processes

3. EOS against the Key implementing Processes

The statistical significance of each correlation coefficient is marked for later use.

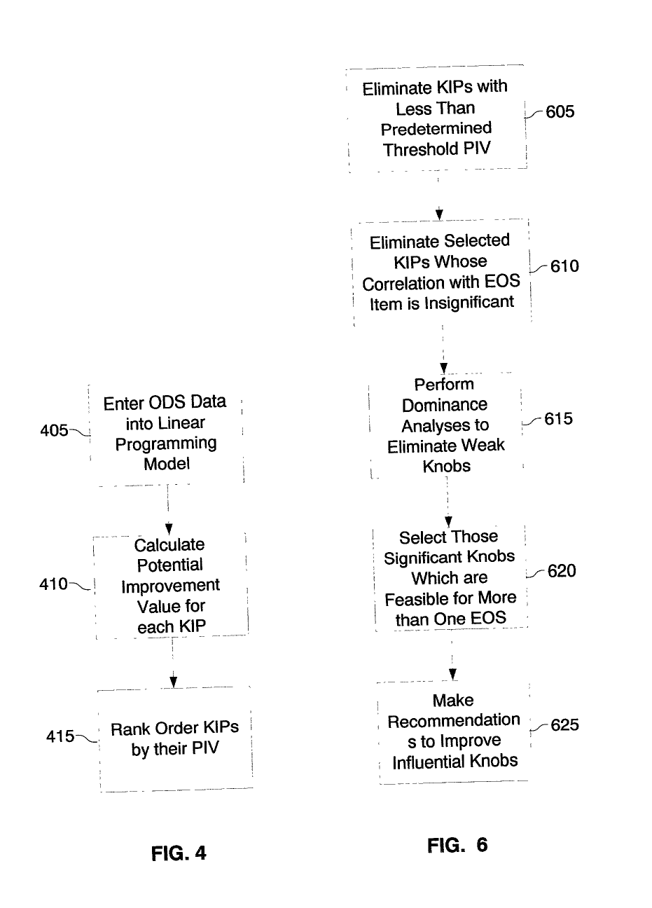

At step 125, a linear programming model is run for the ODS data. The linear programming model is an optimization method in which one mathematically computes the values of how much each Key Implementing Process (KIP) can be improved given a set of constraints. The constraints incorporate known interdependencies. Each KIP is a process and is knobby. Basically, the linear programming technique “twists” each knob (KIP) to its limits to determine the optimal mix. FIG. 4 illustrates the three stages In conducting the linear programming model analyses for the ODS information. Linear programming results are used to inform the reaching of recommendations and are possible because of the use of knobby scales for each ODS item. Initially, at step 404, the ODS data is entered into the linear programming model, described below.

Linear Programming Model

The present system subjects the holonomic property information to linear programming. First, the holonomic properties for the entire sample are calculated. The potential improvement value for each KIP can then be determined, according to the procedure set forth below (step 410). The linear programming model is to:

$$max Z = {\sum }_{j} {WH}_{j} Δ {x}_{j}$$

subject to 12 constraints for the 12 Holonomic processes:

$$1. {\sum }_{{}_{j} ∈ {HP}_{k}} {n}_{j Δ} {x}_{j} - \leq {\sum }_{{}_{j} ∈ {HP}_{k}} {n}_{j} ( {x}_{j}^{*} - {x}_{j}^{∘} ) k = 1 , 2 , … , 12$$

with utilization constraint:

$$2. {\sum }_{j} {}_{Δ}^{}{x}{}_{j}^{} \leq {FG}^{*}$$

and non-negotiating constraint:

3. _{Δ}xⱼ>0 for all KIPs allowable in the ODS Form

In the above equations, xj^{o} is the computed value of the j^{th} KIP; xⱼ* is the maximum, realistic opportunity improvement for the j^{th} KIP; _{Δ}xⱼ is the computed improvement value of the j^{th} KIP; WHⱼ is the number of HPs involving the j^{th} KIP multiplied by the number of items, nⱼ, in the j^{th} KIP.

$${G}^{*} is {\sum }_{j} ( {x}_{j}^{*} - {x}_{j}^{∘} ) ;$$

and F=0, 0.10, 0.25, 0.50, and 1.00.

If F is 0, no improvements are attempted to improve any of the KIPs. If F is 1.0, an attempt is made to improve every KIP to its maximum computed value in the linear programming model. The maximum realistic improvement in a KIP is taken is based on direct intervention experience and involves two principles: (1) the lower the value of the KIP, the more it can be improved and (2) the higher the KIP value, the more difficult it becomes to make an improvement.

The structure of the linear programming model includes the known and theoretical linkages among the KIPs, HPs, and DOCs. Thus, the linear programming takes the constraints and searches for the maximum improvement in the overall degree to which an organization can be an organizational hologram. By varying F values one can see which KIPs have the greatest leverage on the overall solution.

For each KIP there is a potential improvement value, PIV, defined by

PIV=WHⱼ(xⱼ*−xⱼ^{o}).

Typically, a small number of KIPs account for most of the potential improvement. Those KIPs with the largest PIV are candidates for making recommendations for organizational improvement.

The results of the linear programming calculations accomplish two things:

(1) they identify, using the organization's own data, the KIPs offering the greatest leverage for improvement; and

(2) they establish a limit to how much the organization can improve in a single stage intervention. This second property is valuable in establishing realistic expectations in what level of improvement is possible given the current state of the organization.

Finally, at step 415, the KIPs are rank ordered by their respective PIVs.

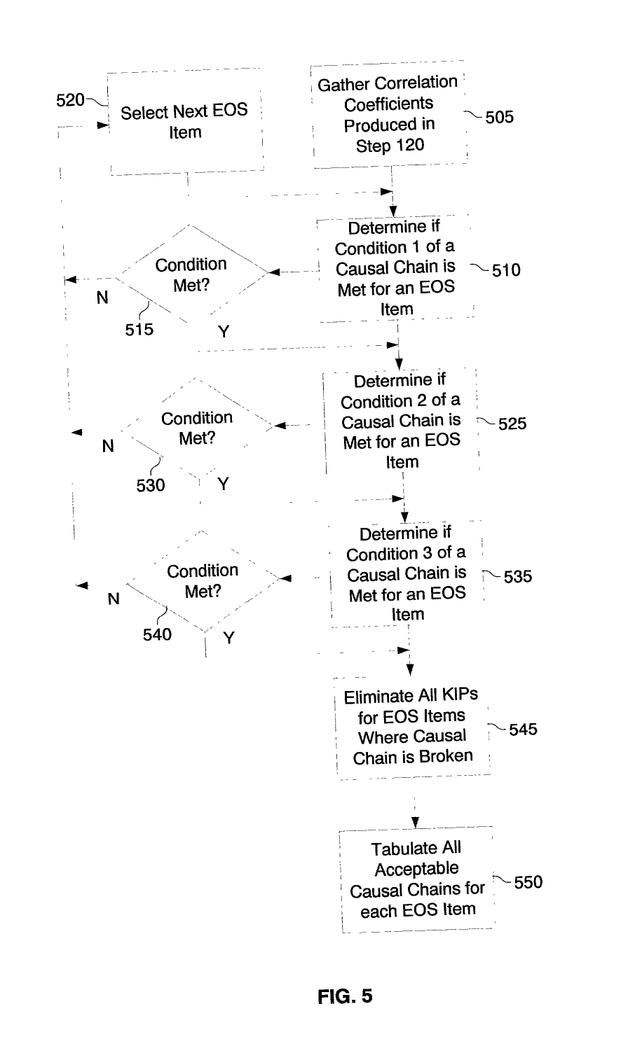

As shown in FIG. 1, at step 130, the causal chains are selected for the EOS items. The stages in step 130 are illustrated in FIG. 5. Before describing the stages in this step, some background is provided, as the present step is important in choosing the knobs to be improved as part of the process of reaching recommendations for client action.

By using both the EOS and one of the ODS survey instruments, one has for each respondent in the client sample: (a) a set of x-axis holonomic properties representing the causal processes under the control of management, and (b) a set of EOS item results, represented on the y-axis. Suppose one uses an ODS form with 62 holonomic properties and an EOS, with 25 items. This produces 62 x-axis variables and 25 y-axis variables, resulting in 1,550 possible pairwise correlations between the 62 ODS and the 25 EOS results. The present system provides a procedure for examining these correlations in order to choose the best knobs for the purpose of improving both the organization (via turning the knobs) and the EOS item scores.

The lower the hierarchical level of a knob in the analytical hierarchy of possible knobs, the greater its specificity for effecting an improvement in the FOS items. In principle, the greater the specificity of a knob, the easier it is to turn in order to effect an improvement in an EOS item. Consequently, for the purpose of determining recommendations, KIP knobs are preferred to HP knobs and HP knobs are preferred to DOC knobs. Hence, the issue of how best to improve EOS item scores becomes the problem of selecting the appropriate KIP knobs.

In principle, the stronger the linkage between a KIP process under the control of management and the score on an EOS item, the greater the efficacy of employing the KIP process to improve the score. A simple measure of this linkage is the correlation coefficient. Let rᵢⱼ denote the correlation coefficient between the j^{th} EOS item and the j^{th} knob (KIP).

At step 505, the correlation coefficients produced in step 120 are used to make the determinations explained below. Steps 510-550 make use of the causal chain. A causal chain is said to exist for an EOS item if three conditions are met:

1. The correlation between the DOC and the EOS item must be statistically significant (step 510). A correlation is considered to be statistically significant if its probability value p is less than approximately 0.01, although p may, alternatively, be selected to be in a range from approximately 0.01 to approximately 0.05. If it is determined that this condition is met (step 515), then the next condition, below, is checked. Otherwise, the next EOS item is selected, at step 520, and the procedure is repeated, beginning at step 510.

2. The correlation between an HP constituent to the DOC, and the EOS item must statistically significant (step 525). If it is determined that this condition is met (step 530), then the next condition, below, is checked.

3. The correlation between the j^{th} KIP, constituent to the HP, and the EOS item must be statistically significant (step 535). If this condition is met (step 540), then, at step 545, the list of KIPs is narrowed down by eliminating all KIPs where it was determined that the causal chain was broken, i.e., where at least one of the above three conditions was not met. At step 550, the remaining KIPs are tabulated for further analysis.

Finally, the j^{th} KIP must be feasible. This determination is made in step 135, as described below

The stages in step 130, as detailed in FIG. 5, identify causal chains between the EOS items and the holonomic properties. The result of step 130 is the tabulation of all acceptable causal chains for each EOS item.

At step 135 (in FIG. 1), feasible knobs (KIPs) are selected for the client. The four main stages in Step 135 are illustrated in FIG. 6. As shown in FIG. 6, the large number of possible correlations between the knobs and the EOS items can be reduced in practice by invoking two procedures:

(1) eliminate all knobs (KIPs) whose potential improvement value, PIVⱼ, is less than some predetermined threshold value, for example, eliminate all knobs for which PIVⱼ is less than or equal to a value of approximately 1 (step 605), and

(2) eliminate all the remaining knobs (KIPs) for any EOS item whose correlation coefficient is above some predetermined level of statistical significance, i.e., whose correlation with an EOS item is insignificant (step 610). In an exemplary embodiment, p (the probability value) is less than approximately 0.01, although p may be selected to be in a range from approximately 0.01 to approximately 0.05. These two rules reduce the number of possible pairs (PIVⱼ, rᵢⱼ).

A knob j is significant with respect to improving EOS item i if it is not eliminated by the two rules for significant PIVⱼ and statistical significance of the correlation, rᵢⱼ, as explained above. Knob j dominates knob k for the purpose of improving the j^{th} item if PIVⱼ>PIVₖ and rᵢⱼ>rᵢₖ. At step 615, dominance analyses are performed to further eliminate the weaker knobs.

Let J be the set of significant knobs for the purpose of improving the i^{th} EOS item. If knob j dominates knob k for the purpose of improving the i^{th} EOS item, then knob k is eliminated from Jᵢ. The set of feasible knobs, J, for EOS item i contains only undominated knobs. A knob is said to be feasible for the purpose of improving the i^{th} EOS item if it is a member of J. Feasibility reduces the number of knobs and their corresponding correlation coefficients.

Not all EOS items merit the investment of time and resources to improve because either they are already acceptable or management, upon reflection, feels that it cannot or does not want to improve them. Consequently, there is a target set of EOS items for possible improvement. The target set further reduces the number of correlations. For each of the EOS items in the target sat, there is a corresponding feasible set of knobs. It usually turns out that some knobs are feasible for more than a single EOS item and some are not feasible for any EOS item.

At step 620, a selection is made of those knobs which are feasible for more than one EOS. Given a statistically significant positive correlation, rᵢⱼ, increasing the value of the j^{th} knob tends to increase the value of the i^{th} EOS item score. Thus, improving the value of a knob usually leads to improvements in the EOS scores. Thus, turning a feasible knob provides two advantages to the organization. First, it improves the holonomic properties by its relative improvement values, PIVⱼ. Second, it improves the EOS scores in the target set for which it is feasible.

However, some knobs have relatively more influence than others in influencing changes in the EOS item scores because they are feasible for more than one EOS item. Because improving the values of feasible knobs affects both the holonomic properties (knob j produces the relative improvement value of PIVⱼ) and the EOS item scores, a summative measure may be calculated for each knob reflecting PIVⱼ and the improvement in the EOS items in the target set.

The greater the influence of a knob, the higher its priority as an intervention. Hence, the greater the knob's influence, the more important it is to recommend an intervention to improve it, as indicated in step 625.

The results from the ODS survey and known interdependencies among the holonomic properties are indicative of how much the knobs, represented as the KIPs, can be improved within a set of constraints from a linear programming model. The linear programming model has an objective function to maximize the sum of the weighted improvements in the calculated values of the KIPs. The weight for each KIP is the product of the number of items in the ODS Survey form for each KIP and the number of HPs that depend upon it. The known interdependencies among the KIPs and HPs are expressed as inequations for each HP. Furthermore, there are assigned constraints (based on prior experiences in other organizations) which limit or constrain how much each KIP can be improved in a one-time intervention. These constraints are based on three observations. First, most organizations have ingrained processes which have grown up over time and are difficult to change quickly. Second, the lower the value of a KIP, the more it can be improved. Third, the better a KIP is operating, the harder it is to improve it. Thus, there are limitations on knob-turning based on the specific values of the KIPs for an organization.

KIPs are given arbitrary numbers, and the following references to various KIPs include a one or two digit number following the KIP for identifying a particular KIP. KIP30, for example, is “Encouraging Best Decision Making”. KIP30 is based on the four items shown below in Table 3.

TABLE 3

| | | | | | | | Don't |
|---|---|---|---|---|---|---|---|
| | Item on ODS Instrument | Never | Rarely | Sometimes | Often | Always | Know |
| 52. | My management fosters | | | | | | |
| | Best Decision Making by | | | | | | |
| a. | Providing education and | 1 | 2 | 3 | 4 | 5 | ? |
| | training in Best Decision | | | | | | |
| | Making | | | | | | |
| b. | Actively using it as they | 1 | 2 | 3 | 4 | 5 | ? |
| | lead and direct our | | | | | | |
| | activities. | | | | | | |
| 53. | My organization makes | 1 | 2 | 3 | 4 | 5 | ? |
| | Best Decisions on all | | | | | | |
| | major decisions facing it. | | | | | | |
| 54. | Employees take | 1 | 2 | 3 | 4 | 5 | ? |
| | responsibility to ensure | | | | | | |
| | Best Decisions are made. | | | | | | |

From Tables 2a and 2b, it can be seen that KIP30, Encouraging Best Decision Making, is constituent in these HPs:

HP3. Ensuring Best Decision Making,

HP6. Integrating Associate Selection, Development, and Flow with the Strategic Direction,

HP8. Ensuring Healthy Problem Solving throughout the Organization.

Thus, KIP30 involves four items (52a, 52b, 53, and 54) and three HPs (3, 6, 8) and thus has a weight of 4×3=12. If the value of KIP30 is 3.00 (it is sometimes a property of the organization), under the constraints it could be improved to 3.75. If the KIP30 value is 4.00 (it is often a property of the organization), it could be improved to 4.50. And if the KIP30 value is 4.40, it could be improved to 4.75. Scores above 4.25 are considered excellent and above 4.50, world class. Most organizations score less than 3.60.

The linear programming solution of the present system provides the potential improvement value for each KIP. The potential improvement value is the product of the calculated improvement of the KIP times its weight. For example, if KIP30 has a value of 4.0, it could be improved to 4.5. Thus, the potential improvement value is (4.5−4.0) 12=6 where 12 is the weight of KIP30. The potential improvement value for knob j is denoted as Vⱼ.

The KIPs can be listed in descending order of their potential improvement values. This makes it quickly apparent which KIPs can be ‘turned’ for the greatest impact.

By using both the EOS and one of the ODS survey instruments, one has: (a) a set of holonomic properties representing the causal processes under the control of management, and (b) a set of EOS item results, for each respondent. Suppose one uses an ODS form with 62 holonomic properties and an EOS with 17 items. This produces 62 x-axis variables and 17 y-axis variables, resulting in 1,054 possible pairwise correlations between the 62 ODS and the 17 EOS results. A procedure is herewith provided for examining these correlations in order to choose the best knobs for the purpose of improving both the organization (via turning the knobs) and the EOS item scores.

In an exemplary embodiment of the present system, analytical hierarchy of the ODS consists of six desired organizational characteristics (DOCs), twelve holonomic processes (HPs) of adaptation and change, 38 to 77 key implementing processes (KIPs), and 152-248 items depending on the ODS Form selected as the instrument. Items are grouped into KIPs such that each item is in one and only one KIP and all items are in a KIP. Each HP is a sum of its KIPs, and some KIPs are used in more than one HP. Each DOC is directly dependent on four HPs plus other KIPs. The analytical hierarchy appears as follows:

Desired Organizational Characteristics

Holonomic Processes

Key Implementing Processes

ODS Items

The lower the hierarchical level of a knob in the hierarchy of possible knobs, the greater its specificity for effecting an improvement in the EOS items. The greater the specificity of a knob, the easier it is to turn in order to effect an improvement in an EOS item. Consequently, for the purpose of determining recommendations, KIP knobs are preferred to HP knobs and HP knobs are preferred to DOC knobs. Hence, the issue of how best to improve EOS item scores becomes a matter of selecting the appropriate KIP knobs.

Not all EOS items merit the investment of time and resources to improve because either they are already acceptable, or management feels that it cannot or does not want to improve them. Consequently, there is a target set of EOS items for possible improvement. The target set further reduces the number of correlations. For each of the EOS items in the target set, there is a corresponding feasible set of knobs.

Given a statistically significant positive correlation, rᵢⱼ, increasing the value of the j^{th} knob tends to increase the value of the i^{th} EOS item score. Thus, improving the value of a knob usually leads to improvements in the EOS scores. Thus, turning a feasible knob provides two advantages to the organization. First, it improves the holonomic properties by its relative improvement values, Vⱼ. Second, it improves the EOS scores in the target set for which it is feasible.

But some knobs have relatively more influence than others in influencing changes in the EOS item scores because they are feasible for more than one EOS item. Because improving the values of feasible knobs affects both the holonomic properties (knob j produces the relative improvement value of Vⱼ) and the EOS item scores, a summative measure could be calculated for each knob reflecting Vⱼ and the improvement in the EOS items in the target set.

The greater the influence of a knob, the higher its priority as an intervention. Hence, the greater the knob's influence, the more important it is to recommend an intervention to improve it.

The items in the ODS forms are different from those typically found in conventional EOS surveys. Each item is knobby. That is, it has the property that it is a “knob” because it represents a process which, if followed, will improve the scores. Furthermore, each statement can be placed in a unique grouping called a Key Implementing Process (KIP), which is also knobby. Each KIP is a part of one or more of the twelve Holonomic Processes (HPs) and also of two or more of the six Desired Organizational Characteristics (DOCs). Some of the main linkages among the KIPs, HPs, and DOCs is listed in Tables 2a, 2b, and 2c, above. These linkages can be exploited in applications. For example, if a KIP has a score of 3.0, this means that those answering the ODS gave an average response of 3.0 on the questions incorporated into that KIP. From Table 4 (below) it can be determined which HPs depend upon this KIP. Thus, if there was an intervention to improve this KIP to a new value, say 4.0, then the impacts on the dependent HPs could be calculated. Similarly, the changes in the DOCs can be determined and the changes in the ODS form values for the Organizational Knowledge, Organizational-Level Learning, and Organizational I.Q.

This “knobby” nature of the ODS statements, coupled with the structure of the supporting theory of the organizational hologram, allows the practitioner the distinct advantage of evaluating the effects of possible interventions of increasing specificity.

Analysis Example

A knobby analysis of data from the national sales organization of a corporation, herein referred to as BioTech, is set forth below.

A seventeen-item Employee Opinion Survey was developed to be administered simultaneously with the ODS forms. The EOS included two questions about BioTech and fifteen items about the sales organization. EOS items included questions about the management, the future, leadership, compensation and benefits, integrity, training and development, and career opportunities. The EOS had an item asking the respondent's opinion about “satisfaction with my treatment by sales management” and another that stated “I would recommend the Sales Organization as a good place to work.”

The ODS instruments were customized to include specific language used at BioTech and to gather pertinent personal and positional data. A Results Report was produced and presented to the senior management of the sales organization. It contained scores for all 62 holonomic properties for the entire sales organization, as well as for each major unit, by organizational rank, by the number and type of products handled, by tenure in the organization, and by gender. It also included parallel information from the seventeen EOS items.

The results were split to investigate gender differences, differences in units, and differences in rank.

Table 4 summarizes the results from the linear programming analysis. It lists the values of 28 KIPs whose potential improvement value exceeded 1.0 and whose weights were greater than or equal to 3. The 28 KIPs in Table 4 account for 92% of the possible improvement if all the KIP knobs were turned to their maximum target value. Note that the KIPs with the higher weights are usually those with the higher rank order as shown in the column on the far right in Table 4. However, KIP32, Ensuring Ethical Decision Making, with a weight of 12, was rank ordered only 16th because of the organization's high values for this KIP.

TABLE 4
Evaluating Potential Improvement Values in the Key Implementing
Processes (KIPs) from ODS Results

| | | | | | Poten- | |
|---|---|---|---|---|---|---|
| | | | | | tial | |
| | | | Com- | | Im- | |
| | | Cur- | puted | | prove- | |
| Key Implementing | | rent | Tar- | | ment | Rank |
| Processes | | Value | get | Weight | Value | Order |
| KIP2. | Understanding and | 3.65 | 4.25 | 8 | 4.80 | 5 |
| | Use of Environments | | | | | |
| KIP3. | Developing and Using | 3.76 | 4.25 | 8 | 3.92 | 11 |
| | the Mission Statement | | | | | |
| KIP4. | Establishing and Using | 3.41 | 4.00 | 4 | 2.36 | 20 |
| | Goals, Strategies, and | | | | | |
| | Tactics | | | | | |
| KIP7. | Ensuring Organizing | 3.12 | 4.00 | 4 | 3.52 | 14 |
| | Assumptions | | | | | |
| KIP8. | Updating and Using | 3.37 | 4.00 | 10 | 6.30 | 2 |
| | the Organizational | | | | | |
| | Logic | | | | | |
| KIP9. | Defining and Updating | 3.03 | 4.00 | 4 | 4.00 | 10 |
| | the Organizational | | | | | |
| | Architecture | | | | | |
| KIP10. | Applying the | 3.73 | 4.25 | 12 | 6.24 | 3 |
| | Organizational | | | | | |
| | Rewards Systems | | | | | |
| KIP11. | Ensuring Results | 3.73 | 4.25 | 3 | 1.56 | 26 |
| | Measurement | | | | | |
| KIP12. | Ensuring Successful | 3.84 | 4.25 | 4 | 1.64 | 25 |
| | Goal Achievement | | | | | |
| KIP14. | Ensuring Compatible | 3.15 | 4.00 | 5 | 4.25 | 9 |
| | Interests of Results | | | | | |
| KIP15. | Using Tough and | 3.68 | 4 25 | 8 | 4.56 | 8 |
| | Realistic Performance | | | | | |
| | Standards | | | | | |
| KIP17. | Applying Total | 3.96 | 4.25 | 4 | 1.16 | 28 |
| | Compensation to | | | | | |
| | Associates | | | | | |
| KIP19. | Ensuring Position | 3.52 | 4.25 | 4 | 2.92 | 17 |
| | Rewards Systems | | | | | |
| KIP20. | Ensuring Compatibil- | 3.45 | 4.00 | 3 | 1.65 | 24 |
| | ity of Associate Goals | | | | | |
| | and Strategies | | | | | |
| KIP22. | Ensuring Compatible | 3.66 | 4.25 | 4 | 1.56 | 27 |
| | Interests among | | | | | |
| | Stakeholders | | | | | |
| KIP26. | Linking Training and | 3.50 | 4.25 | 4 | 3.00 | 15 |
| | Development to Strate- | | | | | |
| | gic Direction | | | | | |
| KIP30. | Encouraging Best | 3.36 | 4.00 | 12 | 7.68 | 1 |
| | Decision Making | | | | | |
| KIP32. | Ensuring Ethical | 4.25 | 4.50 | 12 | 3.00 | 16 |
| | Decision Making | | | | | |
| KIP33. | Using Organizational | 3.56 | 4.25 | 8 | 4.72 | 6 |
| | Forums | | | | | |
| KIP34. | Managing Conflict | 3.44 | 4.00 | 3 | 1.68 | 23 |
| KIP35. | Ensuring Results | 3.58 | 4.25 | 4 | 2.68 | 18 |
| | Oriented Problem | | | | | |
| | Solving | | | | | |
| KIP37. | Amplifying Rewards | 2.88 | 3.75 | 3 | 2.61 | 19 |
| KIP38. | Rewarding Opportun- | 3.08 | 4.00 | 5 | 4.60 | 7 |
| | istic and Innovative | | | | | |
| | Problem Solving | | | | | |
| KIP39. | Ensuring Quality | 4.15 | 4.50 | 6 | 2.10 | 21 |
| KIP72. | Selecting Improved | 3.81 | 4 25 | 8 | 3.52 | 13 |
| | Technologies | | | | | |
| KIP73. | Deploying Improved | 3.64 | 4.25 | 5 | 3.66 | 12 |
| | Technologies | | | | | |
| KIP74. | Managing New Tech- | 3.50 | 4.00 | 10 | 5.00 | 4 |
| | nology Integration | | | | | |
| KIP75. | Integrating New Tech- | 3.66 | 4.25 | 3 | 1.77 | 22 |
| | nology with Strategic | | | | | |
| | Direction | | | | | |

The data in the above table comprises the following data and results:

Current Value: xⱼ^{o}: Primary results from the ODS.

Computed Target: xⱼ*: Computed from knowledge of the current results using the linear programming model.

Size of Improvement: ΔXⱼ=Xⱼ^{*}−Xⱼ^{o}

Relative Improvement Value: Vⱼ=WH_{jΔ}xⱼ; where WHⱼ; number of items in KIP times the number of HPs of which it is a part.

Note that the top 28 KIPs account for 92% of the potential improvement. The remaining 10 KIPs account for the other 8%. The large number of holonomic properties (62) and the 17 EOS items generate over 1,000 correlations for each split of the database. The procedure for reducing this complexity, as described above, is used in this example. At the beginning there were 17 EOS items and 56 holonomic properties (excluding six dynamic congruency conditions), resulting in 952 correlations.

Step one is to eliminate those knobs whose potential improvement value (from the linear programming model) is less than or equal to unity. Step one eliminates 28 of the knobs and 28(17)=476 of the correlations. Step two is to eliminate the remaining correlation coefficients whose significance is less than 0.01.

Step two results in a further reduction of 99 correlations.

Step three is to reduce the surviving knobs by eliminating all dominated knobs. A knob dominates another with respect to an EOS item if it has a larger potential improvement value and a higher correlation with the EOS item. Step three in this case eliminates 12 more knobs and 200 more correlations. This procedure reduces the number of knobs by 75% (42/56) and the number of correlations by 81.4% (775/952). KIP30, Encouraging Best Decision Making, was significant for all 17 of the knobs, which makes it a good candidate for a recommendation to the client organization's management.

Finally, a recommendation for client action is determined based on the preceding analyses. This recommendation is based on facts and computational outcomes. However, the client may have other considerations which will influence its selection of recommendations. These can include budget issues, legal constraints which may limit choice, existence of other on-going projects, considerations of political issues, assessment of “in-house”(capabilities, pending organizational changes such as a merger, and many more. The client, working with the consultant, selects the final recommendations for taking action to improve the EOS results and the organization itself.

While preferred embodiments of the present invention have been shown in the drawings and described above, it will be apparent to one skilled in the art that various embodiments of the present invention are possible. For example, the specific Desired Organizational Characteristics, Holonomic Processes, and Key Implementing Processes, as well as the specific set of steps described above should not be construed as limited to the specific embodiments described herein. Modification may be made to these and other specific elements of the invention without departing from its spirit and scope as expressed in the following claims.

I claim:

1. A system for analysis of an employee survey administered to the employees of an organization, the system comprising the steps of:
administering the employee opinion survey and an organizational diagnostic survey to members of the organization;
producing results for the employee opinion survey;
producing results for the organizational diagnostic survey;
calculating correlations between holonomic properties and items in the employee opinion survey to produce correlation coefficients between items in the employee opinion survey and corresponding knobs;
determining an ordered set of said knobs by selecting the knobs having relatively highest leverage using the results from the organizational diagnostic survey;
selecting a causal chain for certain of the items in the employee opinion survey by using the correlation coefficients to determine linkage between a process under the control of management and the score on each said employee opinion survey item; and
selecting feasible knobs for the organization by eliminating, from said ordered set, all said knobs whose potential improvement value is less than a predetermined number, and eliminating all the remaining knobs for any said employee opinion survey item whose correlation coefficient is above a predetermined level of statistical significance.

2. The system of claim 1, wherein:
said results for the employee opinion survey comprise means and distribution of the responses of those in the organization for each of the items in the employee opinion survey, and
said results for the organizational diagnostic survey comprise means and distribution of the holonomic properties of those in the organization.

3. The system of claim 1, wherein said holonomic properties include desired organizational characteristics and key implementing processes.

4. The system of claim 1, wherein each of said knobs is a process that establishes and defines a causal and functional relationship between a process cause and the outcome thereof.

5. The system of claim 1, wherein said organizational diagnostic survey is a holistic diagnostic survey instrument, said items therein being knobby and employing knobby scales.

6. The system of claim 1, wherein said step of determining said ordered set includes running a linear programming model on the results from the organizational diagnostic survey to determine the knobs having relatively highest leverage.

7. The system of claim 1, including the additional step of reducing the number of said feasible knobs by eliminating knobs related to common said items in the employee opinion survey that have smaller potential improvement values and lower correlations with the common said items.

8. The system of claim 7, including the additional step of selecting said knobs that are feasible for more than one said employee opinion survey.

9. The system of claim 1, wherein said predetermined number is less than or equal to a value of approximately 1.

10. The system of claim 9, wherein said level of statistical significance is indicated by a probability value of approximately 0.01.

11. The system of claim 9, wherein said level of statistical significance is indicated by a probability value in a range from approximately 0.01 to approximately 0.05.

12. The system of claim 1, wherein:
the step of producing results for the employee opinion survey includes:
generating results for a plurality of data splits;
statistically analyzing different groups in said splits to determine whether a statistically significant difference exists for each of the items in the employee opinion survey, for each of said splits; and
identifying significant said splits for each of the items in the employee opinion survey; and
the step of producing results for the organizational diagnostic survey includes:
generating holonomic property results for each of said splits;
calculating the statistical significance of any differences in the holonomic property results by examining the differences in means for each holonomic property for each of said splits; and
tabulating statistically significant differences in means for each holonomic property and said splits.

13. A system for analysis of an employee survey administered to the employees of an organization, wherein an organizational diagnostic survey was concurrently administered to the employees, the system comprising the steps of:
calculating correlations between holonomic properties and items in the employee opinion survey to produce correlation coefficients between items in the employee opinion survey and corresponding knobs;
determining an ordered set of said knobs by selecting the knobs having relatively highest leverage using the results from the organizational diagnostic survey;
selecting a causal chain for certain of the items in the employee opinion survey by using the correlation coefficients to determine linkage between a process under the control of management and the score on each said employee opinion survey item; and
selecting feasible knobs for the organization by eliminating, from said ordered set, all said knobs whose potential improvement value is less than a predetermined number, and eliminating all the remaining knobs for any said employee opinion survey item whose correlation coefficient is above a predetermined level of statistical significance.

14. The system of claim 13, wherein:
said results for the employee opinion survey comprise means and distribution of the responses of those in the organization for each of the items in the employee opinion survey, and
said results for the organizational diagnostic survey comprise means and distribution of the holonomic properties of those in the organization.

15. The system of claim 13, wherein said holonomic properties include desired organizational characteristics and key implementing processes.

16. The system of claim 13, wherein each of said knobs is a process that establishes and defines a causal and functional relationship between a process cause and the outcome thereof.

17. The system of claim 13, wherein said organizational diagnostic survey is a holistic diagnostic survey instrument, said items therein being knobby and employing knobby scales.

18. The system of claim 13, wherein said step of determining said ordered set includes running a linear programming model on the results from the organizational diagnostic survey to determine the knobs having relatively highest leverage.

19. The system of claim 13, including the additional step of reducing the number of said feasible knobs by eliminating knobs related to common said items in the employee opinion survey that have smaller potential improvement values and lower correlations with the common said items.

20. The system of claim 19, including the additional step of selecting said knobs that are feasible for more than one said employee opinion survey.

21. The system of claim 13, wherein the step of producing results for the employee opinion survey includes:
generating results for a plurality of data splits;
statistically analyzing different groups in said splits to determine whether a statistically significant difference exists for each of the items in the employee opinion survey, for each of said splits; and
identifying significant said splits for each of the items in the employee opinion survey;
and wherein the step of producing results for the organizational diagnostic survey includes:
generating holonomic property results for each of said splits;
calculating the statistical significance of any differences in the holonomic property results by examining the differences in means for each holonomic property for each of said splits; and
tabulating statistically significant differences in means for each holonomic property and said splits.

22. The system of claim 13, wherein said predetermined number is less than or equal to a value of approximately 1.

23. The system of claim 22, wherein said level of statistical significance is indicated by a probability value of approximately 0.01.

24. A system for analysis of an employee survey collected from the employees of an organization, comprising the steps of:
concurrently administering the employee opinion survey and an organizational diagnostic survey to members of the organization;
producing results for the employee opinion survey;
producing results for the organizational diagnostic survey;
calculating correlations between holonomic properties and items in the employee opinion survey to produce correlation coefficients between items in the employee opinion survey and corresponding knobs;
wherein said holonomic properties include desired organizational characteristics and key implementing processes; and
wherein each of said knobs is a process that establishes and defines a causal and functional relationship between a process cause and the outcome thereof;
determining an ordered set of said knobs by selecting the knobs having relatively highest leverage using the results from the organizational diagnostic survey by running a linear programming model on the results from the organizational diagnostic survey;
selecting a causal chain for certain of the items in the employee opinion survey by using the correlation coefficients to determine linkage between a process under the control of management and the score on each said employee opinion survey item;
selecting feasible knobs for the organization by eliminating, from said ordered set, all said knobs whose potential improvement value is less than or equal to a value of approximately 1, and eliminating all the remaining knobs for any said employee opinion survey item whose correlation coefficient is above statistical significance indicated by a probability value of approximately 0.01; and
reducing the number of said feasible knobs by eliminating knobs related to common said items in the employee opinion survey that have smaller potential improvement values and lower correlations with the common said items.

25. The system of claim 11, wherein said organizational diagnostic survey is a holistic diagnostic survey instrument, said items therein being knobby and employing knobby scales.

26. The system of claim 11, wherein the step of producing results for the employee opinion survey includes:
generating results for a plurality of data splits;
statistically analyzing different groups in said splits to determine whether a statistically significant difference exists for each of the items in the employee opinion survey, for each of said splits; and
identifying significant said splits for each of the items in the employee opinion survey;
and wherein the step of producing results for the organizational diagnostic survey includes:
generating holonomic property results for each of said splits;
calculating the statistical significance of any differences in the holonomic property results by examining the differences in means for each holonomic property for each of said splits; and
tabulating statistically significant differences in means for each holonomic property and said splits.
